(19) United States
(12) Patent Application Publication
(10) Pub. No.: US 2022/0090619 A1
(43) Pub. Date: Mar. 24, 2022

(54) GROOVED SELF PIERCING RIVET

(71) Applicant: Ford Global Technologies, LLC, Dearborn, MI (US)

(72) Inventors: Andrey M. Ilinich, Novi, MI (US); S. George Luckey, JR., Dearborn, MI (US); Amanda Kay Freis, Ann Arbor, MI (US); Garret Sankey Huff, Ann Arbor, MI (US)

(73) Assignee: Ford Global Technologies, LLC, Dearborn, MI (US)

(21) Appl. No.: 17/030,646

(22) Filed: Sep. 24, 2020

(51) Int. Cl. F16B 19/08; F16B 5/04; B62D 27/02

(52) U.S. Cl. CPC F16B 19/086; B62D 27/023; F16B 5/04

(57) ABSTRACT

A self-piercing rivet (SPR) includes a head portion and a shaft extending from the head portion. The shaft defines a hollow bore and a sidewall surrounding the hollow bore. The sidewall has a reduced thickness towards a distal end portion of the shaft to define a cutting edge on a distal end tip of the shaft, and the SPR defines a circumferential groove disposed at least partially around the shaft and extending into the sidewall.

### FIELD

The present disclosure relates to fasteners, and more particularly to self-piercing rivets.

### BACKGROUND

The statements in this section merely provide background information related to the present disclosure and may not constitute prior art.

Self-piercing riveting has become a popular technique to join two or more workpieces. In self-piercing riveting, a preformed hole is not required. The self-piercing riveting connection is achieved by using a rivet and a die. By placing the workpieces between the rivet and the die and by using a punch to press the rivet against the workpieces, the insertion end of the rivet pierces and plastically deforms the workpieces. The insertion end of the rivet and the adjacent portions of the workpieces are deformed inside a cavity of the die, thereby forming a riveted joint.

Punching and deforming the self-piercing rivet (SPR) and the adjacent portions of the workpieces, however, subjects the insertion end of the SPR to a highly localized strain, which may cause cracking in the SPR or the workpieces. Moreover, for workpieces made of certain materials, the insertion end of the SPR may be not be properly deformed inside the cavity of the die and a desired riveted joint cannot be achieved.

These issues related to the use of SPRs to join workpieces are addressed by the present disclosure.

### SUMMARY

This section provides a general summary of the disclosure and is not a comprehensive disclosure of its full scope or all of its features.

In one form, a self-piercing rivet is provided, which includes a head portion and a shaft extending from the head portion. The shaft defines a hollow bore and a sidewall surrounding the hollow bore. The sidewall has a reduced thickness towards a distal end portion of the shaft to define a cutting edge on a distal end tip of the shaft, and a circumferential groove is disposed at least partially around the shaft and extends into the sidewall.

In other features, the head portion has a diameter larger than a diameter of the shaft. The head portion is solid. The circumferential groove extends into at least 5% of a thickness of the sidewall, and extends around an entire periphery of the sidewall.

In another form, a structural assembly is provided, which includes an upper substrate, a lower substrate disposed proximate the upper substrate, and a self-piercing rivet extending through the upper substrate and into a portion of the lower substrate. The self-piercing rivet includes a head portion, a shaft extending from the head portion and comprising a hollow bore and a sidewall surrounding the hollow bore. The sidewall has a reduced thickness towards a distal end portion of the shaft to define a cutting edge on a distal end tip of the shaft. A circumferential groove is disposed at least partially around the shaft and extends into the sidewall. During installation of the self-piercing rivet, the circumferential groove collapses on itself and directs flaring of the self-piercing rivet into the lower substrate.

In other features, the self-piercing rivet does not extend through a bottom surface of the lower substrate. In one form, a material of the lower substrate does not flow into the circumferential groove. However, it should be understood that in other forms, some of the material of the lower substrate may flow into the circumferential groove before the circumferential groove fully collapses on itself. In one form, the upper substrate includes a steel material and the lower substrate includes an aluminum casting. The structural assembly further includes at least one additional substrate disposed between the upper substrate and the lower substrate. The head portion of the self-piercing rivet has a diameter larger than a diameter of the shaft. The circumferential groove of the self-piercing rivet defines a width of at least 5% of a thickness of the sidewall. The circumferential groove extends around an entire periphery of the sidewall.

In still another form, a structural assembly is provided, which includes an upper substrate, a lower substrate disposed proximate the upper substrate, and a self-piercing rivet extending through the upper substrate and into a portion of the lower substrate. The self-piercing rivet includes a head portion, a shaft portion, and a circumferential groove. The shaft extends from the head portion and includes a hollow bore and a sidewall surrounding the hollow bore. The sidewall has a reduced thickness towards a distal end portion of the shaft to define a cutting edge on a distal end tip of the shaft. The circumferential groove is disposed at least partially around the shaft and extends into the sidewall. During installation of the self-piercing rivet, the circumferential groove collapses on itself and directs flaring of the self-piercing rivet into the lower substrate. In one form, the self-piercing rivet does not extend through a bottom surface of the lower substrate. In another form, a material of the lower substrate does not flow into the circumferential groove.

In still other features, the upper substrate includes a steel material and the lower substrate includes an aluminum casting. The structural assembly further includes at least one additional substrate disposed between the upper substrate and the lower substrate. The head portion of the self-piercing rivet includes a diameter larger than a diameter of the shaft. The circumferential groove of the self-piercing rivet extends around an entire periphery of the sidewall.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 depicts various steps of installing a self-piercing rivet (SPR) into workpieces in accordance with the teachings of the present disclosure, wherein: the SPR is disposed above the workpieces and is held by an installation tool at step A; a punch of the installation tool is actuated to press the SPR against the workpieces at step B; an insertion end of the SPR penetrates into the workpieces to deform a portion of the workpieces and the insertion end of the SPR into a die cavity to form a rivet joint at step C; and the punch is lifted after the rivet joint is formed at step D;

FIG. 2A is a perspective view of a self-piercing rivet constructed in accordance with the teachings of the present disclosure;

FIG. 2B is a cross-sectional view, taken along line 2B-2B of FIG. 2A;

FIGS. 3A and 3B are axisymmetric cross-sectional views from a 2D finite element model (FEM) of a conventional SPR and an SPR constructed in accordance with the teachings of the present disclosure, respectively, wherein the conventional SPR and the SPR of the present disclosure are shown to be positioned between a punch and workpieces to be joined;

FIGS. 4A and 4B are axisymmetric cross-sectional views from the 2D FEM of a conventional SPR and an SPR constructed in accordance with the teachings of the present disclosure, respectively, wherein the SPRs are shown to pierce through an upper substrate and into a portion of a lower substrate to deform the upper substrate and the lower substrate and the insertion portion of the SPRs into a die cavity;

FIGS. 5A and 5B are FEM predicted effective plastic strain distributions corresponding to FIGS. 4A and 4B showing the strains at various portions of the lower substrate;

FIGS. 6A and 6B are axisymmetric cross-sectional views from the 2D FEM of a conventional SPR and an SPR constructed in accordance with the teachings of the present disclosure, respectively, wherein the SPRs are shown to pierce through an upper substrate and into a portion of a lower substrate to deform the upper substrate and the lower substrate and the insertion portion of the SPRs into a die cavity;

FIGS. 7A and 7B are predicted effective plastic strain distributions corresponding to FIGS. 6A and 6B showing the strain at various portions of the lower substrate; and

FIGS. 8A and 8B are cross-sectional views illustrating exemplary forms of additional substrates according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

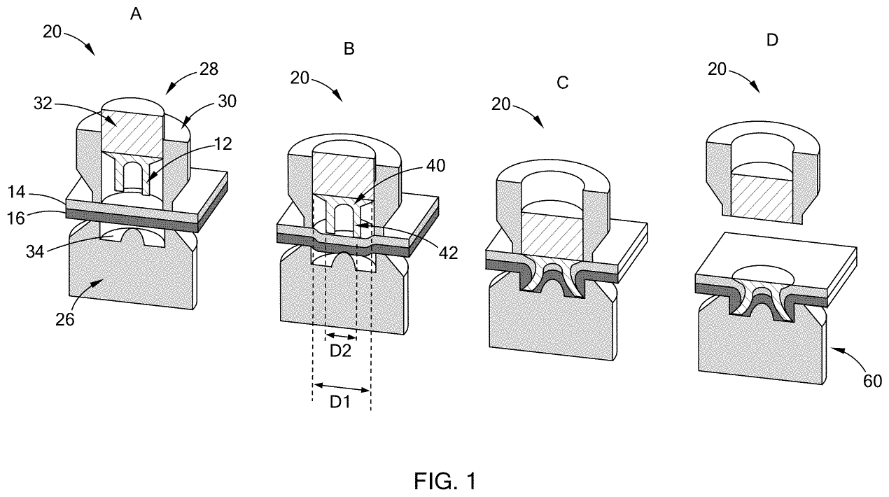

Referring to FIG. 1, a self-piercing rivet (SPR) 12 constructed in accordance with the teachings of the present disclosure is used to join workpieces which may include an upper substrate 14 and a lower substrate 16. The SPR 12 is installed to the upper and lower substrates 14, 16 by an installation tool 20 including a die 26 and a punch assembly 28. The punch assembly 28 is disposed above the upper and lower substrates 14, 16 and includes a punch holder 30 and a punch 32 movably received within the punch holder 30. The SPR 12 is disposed inside the punch holder 30 and below the punch 32. The die 26 is disposed under the upper and lower substrates 14, 16 and defines a cavity 34 into which a portion of the SPR 12 and portions of the upper and lower substrates 14 and 16 are to be deformed.

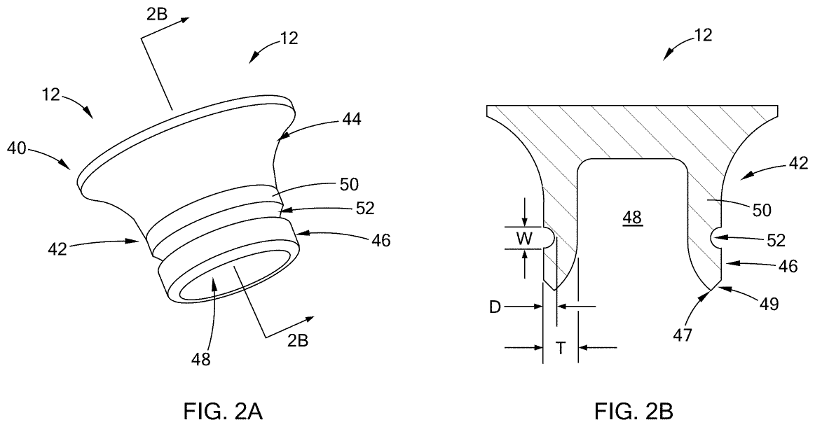

Referring to FIGS. 2A and 2B in conjunction with FIG. 1, the SPR 12 constructed in accordance with the teachings of the present disclosure includes a head portion 40 and a shaft 42 extending from the head portion 40. The shaft 42 is an insertion portion of the SPR 12 that is used to pierce into the workpieces and that is deformed inside the cavity 34 of the die 26. The shaft 42 has a proximal end portion 44 proximate the head portion 40 and a distal end portion 46 away from the head portion 40. The shaft 42 defines a hollow bore 48 and a sidewall 50 surrounding the hollow bore 48. A circumferential groove 52 is disposed at least partially around the shaft 42 and extends into the sidewall 50 proximate the distal end portion 46 of the shaft 42. In one example, the circumferential groove 52 extends around an entire periphery of the sidewall 50. As clearly shown in FIG. 1, the head portion 40 has a truncated cone shape and has an outside diameter D1 larger than an outside diameter D2 of the shaft 42. While the head portion 40 is shown in the figures to be solid, the head portion 40 can be hollow without departing from the scope of the present disclosure.

As further shown in FIG. 2B, the sidewall 50 of the shaft 42 has a reduced thickness towards the distal end portion 46 of the shaft to define a cutting edge 47 on a distal end tip 49 of the shaft 42. More specifically, this cutting edge 47 can be observed towards the distal end portion 46 where the thickness of the sidewall 50 decreases and the end of the SPR 12 comes generally to a bevel at the distal end tip 49. In one example, a depth “D” of the circumferential groove 52 extends into at least 5% of a thickness “T” of the sidewall 50, and a width “W” is at least 5% of the thickness “T” of the sidewall 50. (i.e., D=0.05×T, W=0.05×T) It should be understood that other depths, widths, and shapes of the circumferential groove 52 may be employed while remaining within the scope of the present disclosure. Further, the circumferential groove 52 may extend along different paths other than the round path, extending generally in the same plane, as illustrated herein. For example, the circumferential groove 52 may take on a helical path (not shown) while remaining within the scope of the present disclosure. Furthermore, while a single circumferential groove 52 is illustrated and described, the SPR 12 may optionally include more than one circumferential groove 52 while remaining within the scope of the present disclosure.

Referring back to FIG. 1, to install the SPR 12 into workpieces, the workpieces include the upper substrate 14 and the lower substrate 16, which are placed between the die 26 and the punch holder 30 at step A. The punch holder 30 and the die 26 jointly form a clamp to sandwich the workpieces/substrates 14, 16 therebetween. As an example, the punch holder 30 and the die 26 may be formed at opposing ends of a C-clamp (not shown). The SPR 12 is received inside the punch holder 30 under the punch 32.

After the upper and lower substrates 14, 16 are properly positioned, the punch 32 is actuated to press the SPR 12 against the upper and lower substrates 14, 16 at step B. The upper and lower substrates 14 16 are significantly deformed at this step. As the punch 32 continues to press the SPR 12 against the upper and lower substrates 14, 16, the shaft 42 of the SPR 12 penetrates through the upper substrate 14 and then partially penetrates into the lower substrate 16 to create a mechanical interlock at step C. The upper and lower substrates 14, 16 and the shaft 42 of the SPR 12 are deformed inside the cavity 34 of the die 26 and partially or completely fill the cavity 34 of the die 26 to form a closed rivet joint in the cavity 34 of the die 26 at step D.

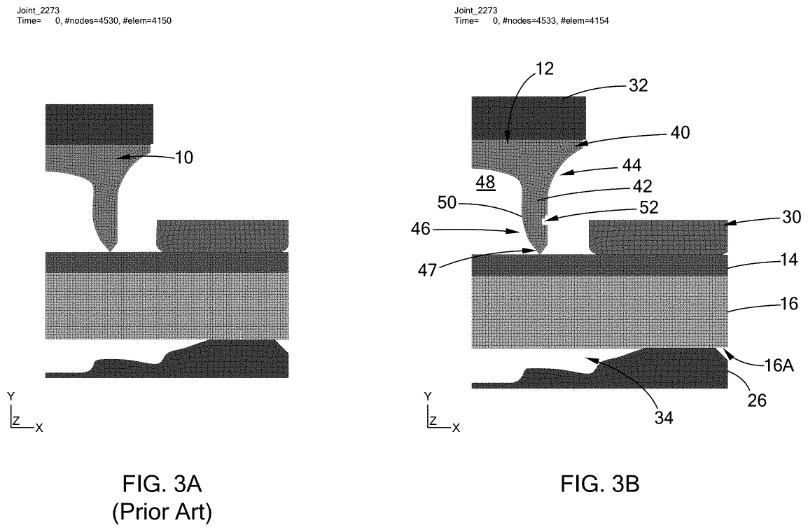

Referring to FIGS. 3A and 3B, both a conventional SPR 10 and the SPR 12 of the present disclosure are illustrated in an axisymmetric 2D finite element model (FEM) before installation. In the axisymmetric illustrations herein, it should be understood that only one half of the SPR is illustrated, which is conventional for analysis purposes.

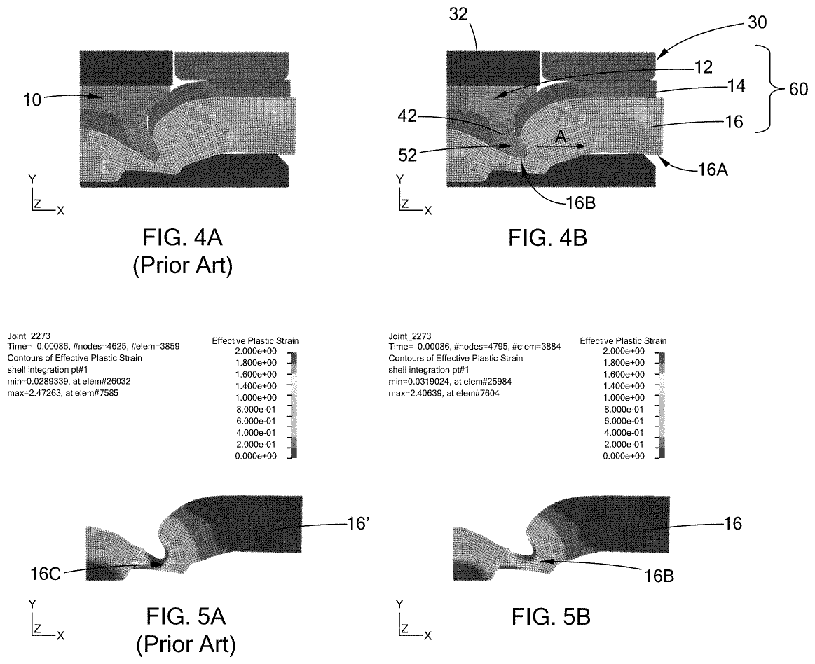

Now referring to FIGS. 4A and 4B, after installation, when the shaft 42 of the SPR 12 penetrates through the upper substrate 14 and then partially penetrates the lower substrate 16, the circumferential groove 52 collapses on itself and is closed due to the compressive forces applied on shaft 42. With the collapsing of the circumferential groove 52, the distal end portion 46 deforms outwardly in the direction of arrow A, and thus directs flaring of the SPR 12 into the lower substrate 16. Because the circumferential groove 52 closes, a material of the lower substrate 16 does not flow into the circumferential groove 52. Accordingly, the SPR 12 defines a material and geometry that causes the circumferential groove 52 to collapse under the compressive forces of the punch 32 and close before any substantial amount of material from the lower substrate 16 can enter the circumferential groove 52. While the circumferential groove 52 is designed so that no material from the lower substrate 16 can enter before the circumferential groove 52 collapses on itself, it should be understood that a small amount of material of the lower substrate 16 may still enter the circumferential groove 52, not effecting the functionality of the circumferential groove 52, while remaining within the scope of the present disclosure.

In one form, the shaft 42 of the SPR 12 does not extend through a bottom surface 16A of the lower substrate 16. Due to the additional/directed flaring of the shaft 42 of the SPR 12, the distance between the deformed shaft 42 and the bottom surface 16A of the lower substrate 16 is increased, compared to a conventional SPR 10 without a circumferential groove. Therefore, the flaring of the shaft 42 of the SPR 12 can further prevent the shaft 42 from undesirably penetrating the bottom surface 16A of the SPR 12, thus allowing more material to be present between the deformed shaft 42 and the bottom surface 16A of the lower substrate 16. This increased amount of material lowers the strains at this location as described in greater detail below, thereby reducing the probability of cracking of the lower substrate 16. In one example, the lower substrate 16 has an increased thickness of about 33% due to the enhanced flaring of the SPR 12.

Referring to FIGS. 5A and 5B, plastic strain of the lower substrate 16 using the conventional SPR 10 compared with the SPR 12 of the present disclosure is shown. With the enhanced flaring of the shaft 42 of the SPR 12, due to the circumferential groove 52 collapsing on itself, the lower substrate 16 is subjected to less strain, particularly in the reduced thickness area 16B between the distal end tip 49 of the deformed shaft 42 and the bottom surface 16A of the lower substrate 16, compared with a substrate 16′ installed with a conventional SPR without any circumferential groove. In one example as shown, (which is high strength steel for the upper substrate 14 and an aluminum casting for the lower substrate 16), the maximum strain in the reduced thickness area 16B of the lower substrate 16 using the SPR 12 of the present disclosure is about 21% less than the strain in the reduced thickness area 16C of a lower substrate using the conventional SPR 10.

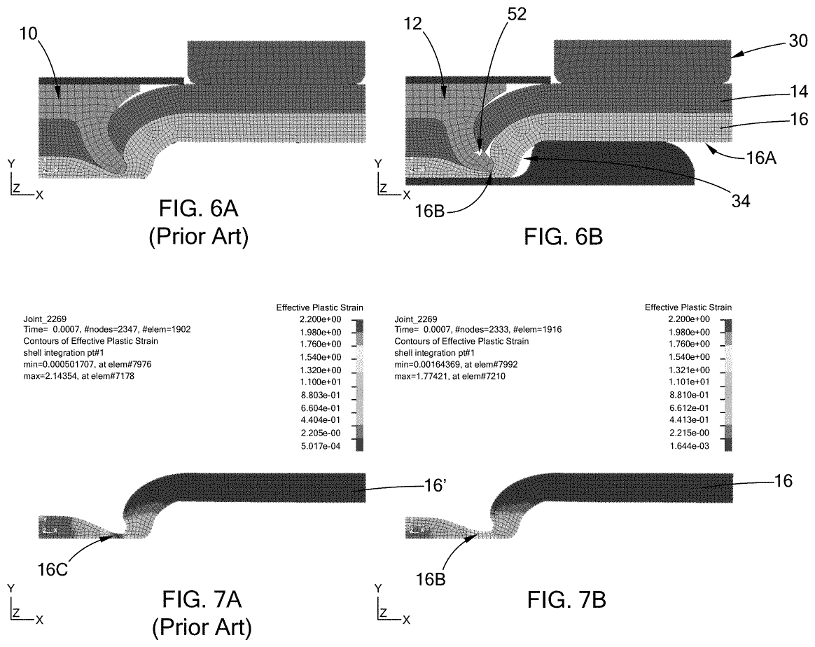

Referring to FIGS. 6A and 6B, these figures are similar to those of FIGS. 4A and 4B except that the upper and lower substrates 14 and 16 have approximately the same thickness. In this example, the material is 6000 series Aluminum. Due to the reduced thickness of the lower substrate 16, the distal end portion 46 of the shaft 42 of the SPR 12, after being deformed, may be disposed at a location closer to the bottom surface 16A of the lower substrate 16, thereby resulting in higher strains at the reduced thickness area 16B.

Referring to FIGS. 7A and 7B, despite the reduced thickness of the lower substrate 16, installation of the SPR 12 with the circumferential groove 52 results in reduced strains in the lower substrate 16, compared to the strains in a lower substrate 16′ with the conventional SPR 10. The strains in the reduced thickness area 16B of the lower substrate 16 is about 25% less than the strain in the reduced thickness area 16C when a conventional SPR 10 is used. By using the circumferential groove 52 to direct the shaft 42 to flare further outwards, the reduced thickness area 16B of the lower substrate 16 is subjected to lower strains and stresses despite the reduced thickness of the lower substrate 16, thereby increasing the integrity of the joined assembly 60. Advantageously, bottom layer thinning of the lower substrate 16 is reduced by about 50%. Moreover, despite the reduced thickness of the lower substrate 16 and less penetration of the SPR 12 into the lower substrate 16, the flared shaft 42 of the SPR 12 increases the contact area between the flared shaft 42 and the lower substrate 16, thereby providing a more robust/secure connection between the SPR 12 and the lower substrate 16.

Referring back to FIG. 1, after the SPR 12 is installed into the upper and lower substrates 14, 16 to form a joined assembly 60, the punch assembly 28 is moved away from the upper and lower substrates 14, 16 to complete installation of the SPR 12. The joined assembly 60 may be used to form a vehicle body and closure parts in automobiles or in any applications which include joining of two or more workpieces.

As shown in FIGS. 4B and 6B, the joined assembly 60 includes an upper substrate 14, a lower substrate 16 disposed proximate the upper substrate 14, and an SPR 12 extending through the upper substrate 14 and into a portion of the lower substrate 16. As previously set forth, the SPR 12 includes a head portion 40, a shaft 42 extending from the head portion 40 and comprising a hollow bore 48 and a sidewall 50 surrounding the hollow bore 48, the sidewall 50 has a reduced thickness towards a distal end portion of the shaft to define a cutting edge on a distal end tip of the shaft. The circumferential groove 52 is disposed at least partially around the shaft 42 and extends into the sidewall 50 proximate the distal end portion 46 of the shaft 42. During installation of the SPR 12, the circumferential groove 52 collapses on itself and directs flaring of the SPR 12 into the lower substrate 16. In one form, the SPR 12 does not extend through a bottom surface 16A of the lower substrate 16. And as previously set forth, a material of the lower substrate 16 does not flow into the circumferential groove 52 in one form of the present disclosure. As one example, the upper substrate 14 comprises a steel material and the lower substrate 16 comprises an aluminum casting. However, it should be understood that other materials may be used for the upper substrate 14 and/or the lower substrate 16 while remaining within the scope of the present disclosure.

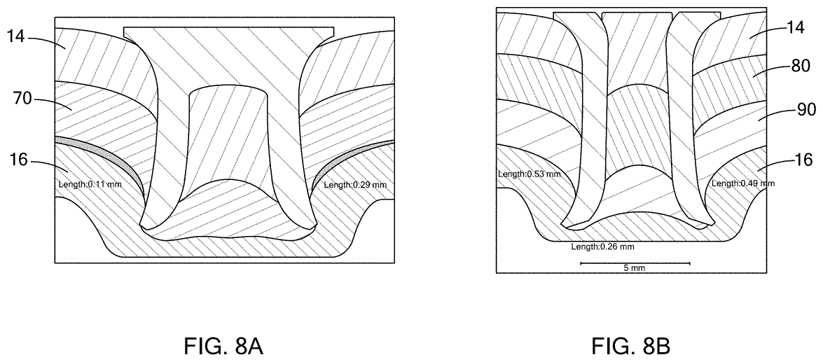

Referring to FIGS. 8A and 8B, while only two substrates have been illustrated herein to be joined by the SPR 12, it should be understood that additional substrates may be included between the upper substrate 14 and the lower substrate 16 without departing from the scope of the present disclosure. In these examples, additional substrates 70 (FIG. 8A) and 80/90 (FIG. 8B) are illustrated with a conventional SPR 10 for purposes of clarity and to demonstrate the presence of additional substrates between the upper substrate 14 and the lower substrate 16. Accordingly, any number of substrates may be employed while remaining within the scope of the present disclosure. Furthermore, while the SPR 12 is illustrated herein with head portion 40 that is closed, the SPR 12 may optionally be constructed such that the hollow bore 48 extends through the head portion 40 as illustrated in FIG. 8B.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A self-piercing rivet comprising:
a head portion;
a shaft extending from the head portion and comprising a hollow bore and a sidewall surrounding the hollow bore, the sidewall having a reduced thickness towards a distal end portion of the shaft to define a cutting edge on a distal end tip of the shaft; and
a circumferential groove disposed at least partially around the shaft and extending into the sidewall.

2. The self-piercing rivet according to claim 1, wherein the head portion comprises a diameter larger than a diameter of the shaft.

3. The self-piercing rivet according to claim 1, wherein the head portion is solid.

4. The self-piercing rivet according to claim 1, wherein the circumferential groove extends into at least 5% of a thickness of the sidewall.

5. The self-piercing rivet according to claim 1, wherein the circumferential groove extends around an entire periphery of the sidewall.

6. A structural assembly comprising:
an upper substrate;
a lower substrate disposed proximate the upper substrate; and
a self-piercing rivet extending through the upper substrate and into a portion of the lower substrate, the self-piercing rivet comprising:
a head portion;
a shaft extending from the head portion and comprising a hollow bore and a sidewall surrounding the hollow bore, the sidewall having a reduced thickness towards a distal end portion of the shaft to define a cutting edge on a distal end tip of the shaft; and
a circumferential groove disposed at least partially around the shaft and extending into the sidewall,
wherein during installation of the self-piercing rivet, the circumferential groove collapses on itself and directs flaring of the self-piercing rivet into the lower substrate.

7. The structural assembly according to claim 6, wherein the self-piercing rivet does not extend through a bottom surface of the lower substrate.

8. The structural assembly according to claim 6, wherein a material of the lower substrate does not flow into the circumferential groove.

9. The structural assembly according to claim 6, wherein the upper substrate comprises a steel material and the lower substrate comprises an aluminum casting.

10. The structural assembly according to claim 6 further comprising at least one additional substrate disposed between the upper substrate and the lower substrate.

11. The structural assembly according to claim 6, wherein the head portion of the self-piercing rivet comprises a diameter larger than a diameter of the shaft.

12. The structural assembly according to claim 6, wherein the circumferential groove of the self-piercing rivet defines a width of at least 5% of a thickness of the sidewall.

13. The structural assembly according to claim 6, wherein the circumferential groove extends around an entire periphery of the sidewall.

14. A vehicle comprising the structural assembly according to claim 6.

15. A structural assembly comprising:
an upper substrate;
a lower substrate disposed proximate the upper substrate; and
a self-piercing rivet extending through the upper substrate and into a portion of the lower substrate, the self-piercing rivet comprising:
a head portion;
a shaft extending from the head portion and comprising a hollow bore and a sidewall surrounding the hollow bore, the sidewall having a reduced thickness towards a distal end portion of the shaft to define a cutting edge on a distal end tip of the shaft; and
a circumferential groove disposed at least partially around the shaft and extending into the sidewall,
wherein during installation of the self-piercing rivet, the circumferential groove collapses on itself and directs flaring of the self-piercing rivet into the lower substrate, and wherein the self-piercing rivet does not extend through a bottom surface of the lower substrate, and a material of the lower substrate does not flow into the circumferential groove.

16. The structural assembly according to claim 15, wherein the upper substrate comprises a steel material and the lower substrate comprises an aluminum casting.

17. The structural assembly according to claim 15 further comprising at least one additional substrate disposed between the upper substrate and the lower substrate.

18. The structural assembly according to claim 15, wherein the head portion of the self-piercing rivet comprises a diameter larger than a diameter of the shaft.

19. The structural assembly according to claim 15, wherein the circumferential groove of the self-piercing rivet extends around an entire periphery of the sidewall.

20. A vehicle comprising the structural assembly according to claim 15.
